(19) United States
(12) Patent Application Publication
(10) Pub. No.: US 2026/0126839 A1
(43) Pub. Date: May 7, 2026

(54) REDUCED VOLTAGE REGULATOR MODULE PHASES

(71) Applicant: International Business Machines Corporation, Armonk, NY (US)

(72) Inventors: Justin Henspeter, Georgetown, TX (US); Eric Jason Fluhr, Leander, TX (US); Gregory Scott Still, Raleigh, NC (US); Eric Marz, Williston, VT (US)

(21) Appl. No.: 18/935,143

(22) Filed: Nov. 1, 2024

(51) Int. Cl. G06F 1/26

(52) U.S. Cl. CPC G06F 1/26

(57) ABSTRACT

A method, according to one approach, includes: detecting a failed phase of a first VRM which causes the first VRM to have a number of functioning phases that is outside a predetermined range. The first VRM is included in a processor system architecture having a plurality of VRMs respectively associated with a plurality of chips. The method also includes causing any workloads on a first chip associated with the first VRM to be offloaded. Moreover, a controlled shutdown of the first VRM and the first chip is performed, while the plurality of VRMs respectively associated with the plurality of chips in the processor system architecture, excluding the first VRM and the first chip, remain operational.

### BACKGROUND

The present invention relates to supply voltages, and more specifically, this invention relates to power supply voltages.

Pluggable voltage regulator modules (VRMs) are generally used to deliver voltage and current to subsystems. For instance, VRMs are used to supply voltage and/or current to sub-systems in servers. When voltage and/or current availability is of particular importance, pluggable VRMs can be designed to be phase redundant. Phase redundancy allows for one or more phases (e.g., power stages) to fail, while seamlessly isolating the failed phase(s) from adjacent (e.g., parallel) phases and allowing the system to continue to operate without fault.

VRM designs consider the minimum number of phases (N) that are associated with supporting a given application under the “worst-case” loading conditions. An additional number of “redundant” phases may also be added to the design for resilience in failure conditions. For example, in a traditional designed VRM, 2 phases can be lost while still supporting the worst-case loading conditions for the underlying system. As supply voltages become more complex, the number of redundant phases associated with maintaining similar resilience increases as well.

### SUMMARY

A method, according to one approach, includes: detecting a failed phase of a first VRM which causes the first VRM to have a number of functioning phases that is outside a predetermined range. The first VRM is included in a processor system architecture having a plurality of VRMs respectively associated with a plurality of chips. The method also includes causing any workloads on a first chip associated with the first VRM to be offloaded. Moreover, a controlled shutdown of the first VRM and the first chip is performed, while the plurality of VRMs respectively associated with the plurality of chips in the processor system architecture, excluding the first VRM and the first chip, remain operational.

A computer program product, according to another approach, includes: one or more computer-readable storage media, and program instructions that are stored on the one or more storage media to perform the foregoing method.

A computer system, according to yet another approach, includes: a processor set having an architecture which includes a plurality of VRMs respectively associated with a plurality of chips. The computer system also includes one or more computer-readable storage media, along with program instructions stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a processor system, in accordance with one approach.

FIG. 2B is a representational view of a progression, in accordance with one approach.

FIG. 3 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for reducing the number of redundant supply voltage phases associated with maintaining operation of underlying chip modules. Approaches herein are able to achieve this by separating the supply voltages such that each chip is provided with a different (e.g., individual) power supply voltage. As a result, a single chip may be taken offline in a controlled manner without impacting performance of the remaining chips in the processor system. Approaches herein are thereby able to achieve a unique power delivery configuration that differs from conventional products and improves performance as a whole, e.g., as will be described in further detail below.

In one general approach, a method includes: detecting a failed phase of a first VRM which causes the first VRM to have a number of functioning phases that is outside a predetermined range. The first VRM is included in a processor system architecture having a plurality of VRMs respectively associated with a plurality of chips. The method also includes causing any workloads on a first chip associated with the first VRM to be offloaded. Moreover, a controlled shutdown of the first VRM and the first chip is performed, while the plurality of VRMs respectively associated with the plurality of chips in the processor system architecture, excluding the first VRM and the first chip, remain operational.

In another general approach, a computer program product includes: one or more computer-readable storage media, and program instructions that are stored on the one or more storage media to perform the foregoing method.

In yet another general approach, a computer system includes: a processor set having an architecture which includes a plurality of VRMs respectively associated with a plurality of chips. The computer system also includes one or more computer-readable storage media, along with program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved supply voltage code at block 150 for reducing the number of redundant VRM phases associated with maintaining operation of underlying chip modules. Approaches herein are able to achieve this by separating the supply voltages such that each chip is provided with a different (e.g., individual) power supply voltage. As a result, a single chip may be taken offline in a controlled manner without impacting performance of the remaining chips in the processor system. Approaches herein are thereby able to achieve a unique power delivery configuration that differs from conventional products and improves performance as a whole, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

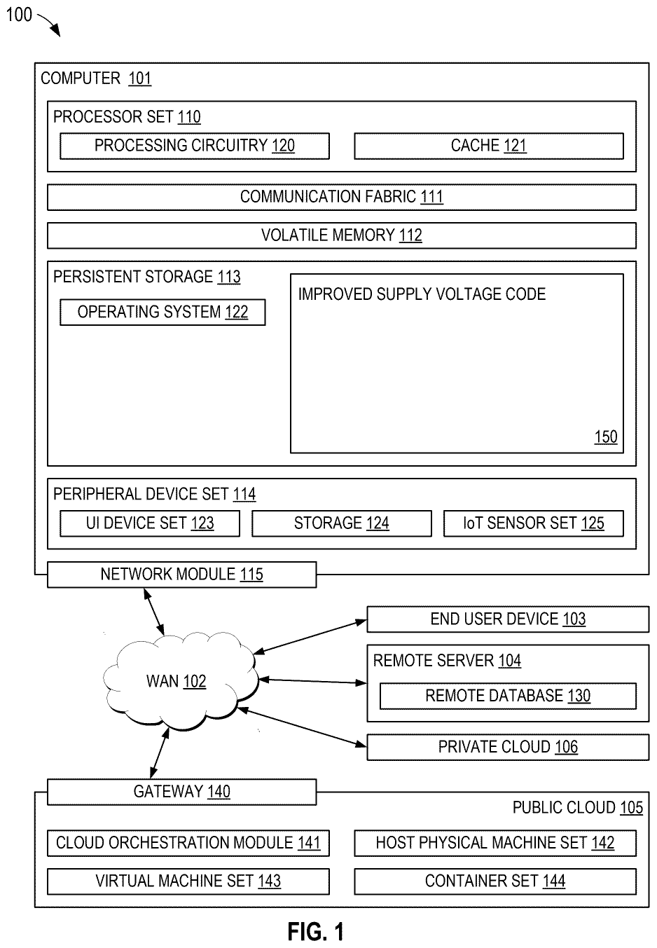

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, pluggable VRMs are generally used to deliver voltage and current to critical subsystems. For instance, VRMs are used to supply voltage and/or current to sub-systems in some high end servers. When voltage and/or current availability is of particular importance, pluggable VRMs can be designed to be phase redundant. Phase redundancy allows for one or more phases (e.g., power stages) to fail, while seamlessly isolating the failed phase(s) from adjacent (e.g., parallel) phases and allowing the system to continue to operate without fault.

VRM designs consider the minimum number of phases (N) that are associated with supporting a given application under the “worst-case” loading conditions. An additional number of “redundant” phases (often 1 or 2) are then added to the design for resilience in failure conditions. For example, in a traditional designed VRM, 2 phases can be lost while still supporting the worst-case loading conditions for the underlying system. However, the total number of phases associated with realizing phase redundancy at a system level has become burdensome as the number of distinct output voltages implemented in systems has increased significantly. One instance of this includes conventional products that have multiple processor rails for a single processor module, as this causes the number of additional phases needed to maintain redundancy costly and difficult to physically package in the limited area available. While a single N+2 regulator equates to including 2 redundant phases, this is true for each regulator in the product. Accordingly, a conventional product that includes eight or more N+2 regulators calls for 16 or more redundant phases.

Even in situations where 2 phases fail and the product is on the verge of losing operating capabilities, conventional products simply call home for a repair and/or replacement VRM. In these situations, the system service processor is aware of the reduced VRM redundancy state, but the processor itself does not. Thus, in situations where an additional phase failure occurs prior to the repair and/or replacement, the remaining phases experience an over current condition. This is because the number of phases may no longer be adequate to support the desired amperage, which has led to conventional products experiencing unintended VRM shutdowns and system crashes. Other existing products implement a single chip module which involves feeding a single voltage for all processor cores. While this voltage can be produced by a pluggable VRM, the voltages applied to the respective chip modules cannot be adjusted individually, further limiting performance.

In sharp contrast to these conventional shortcomings, approaches herein are desirably able to reduce the number of redundant VRM phases associated with maintaining operation of the underlying chip modules. This is achieved at least in part through isolation of processor chips at critical ranges (e.g., thresholds) of redundancy loss. This is particularly desirable as the number of individually controllable voltage rails available at a system level continue to significantly increase for processors. Again, the process of physically packaging N+2 redundant phases for each regulator has been prohibitive to conventional designs by consuming available space, increasing associated costs, increasing complexity, etc. However, by reducing the total number of phases associated with meeting worst-case loading conditions, as well as enabling processors to shut down specific chips while allowing adjacent chips to continue to function, approaches herein are able to dramatically reduce the total number of VRM phases that are implemented in a system. Approaches herein thereby reduce overall system cost and simplify system design, while also preserving system availability, e.g., as will be described in further detail below.

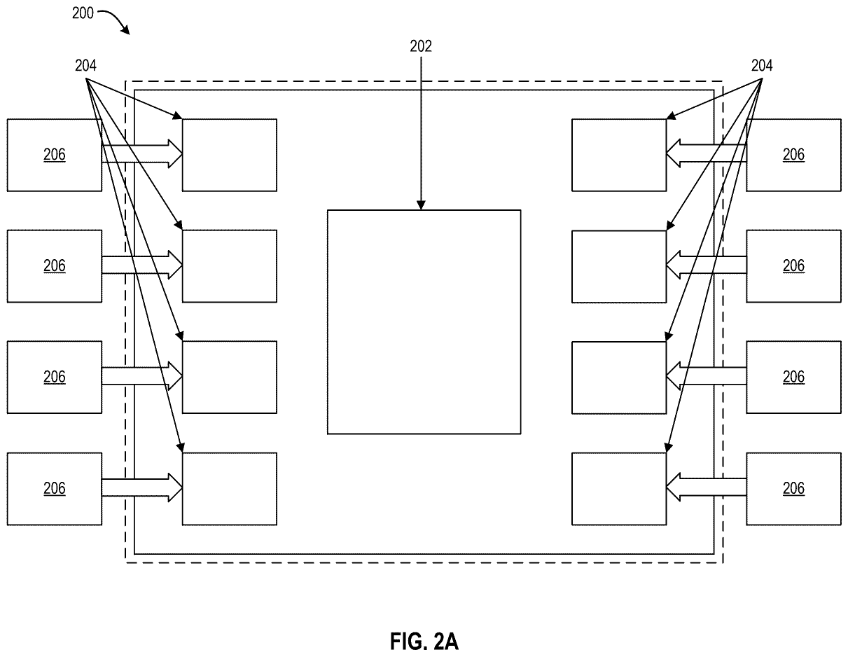

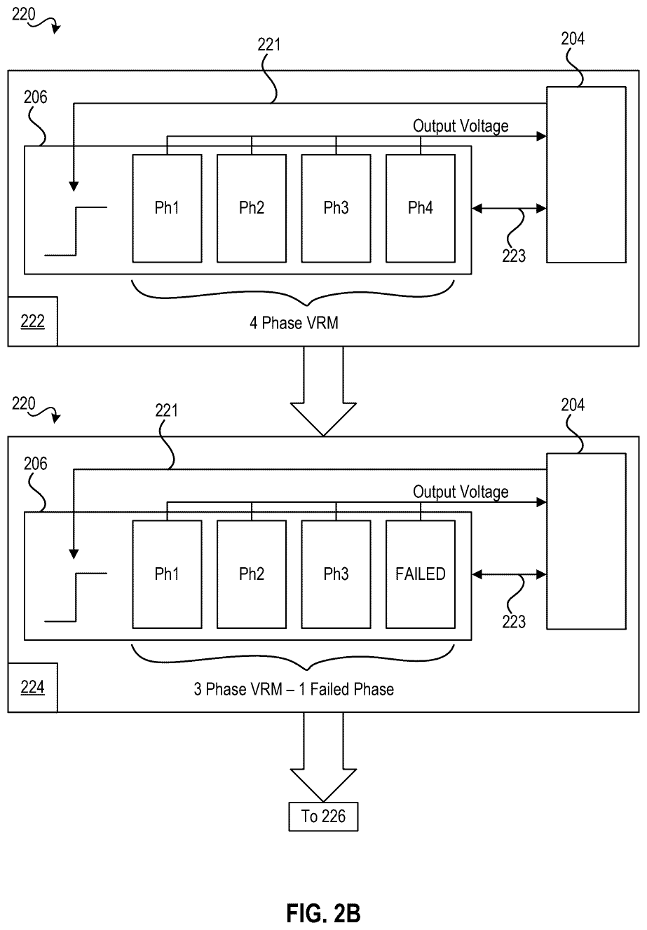

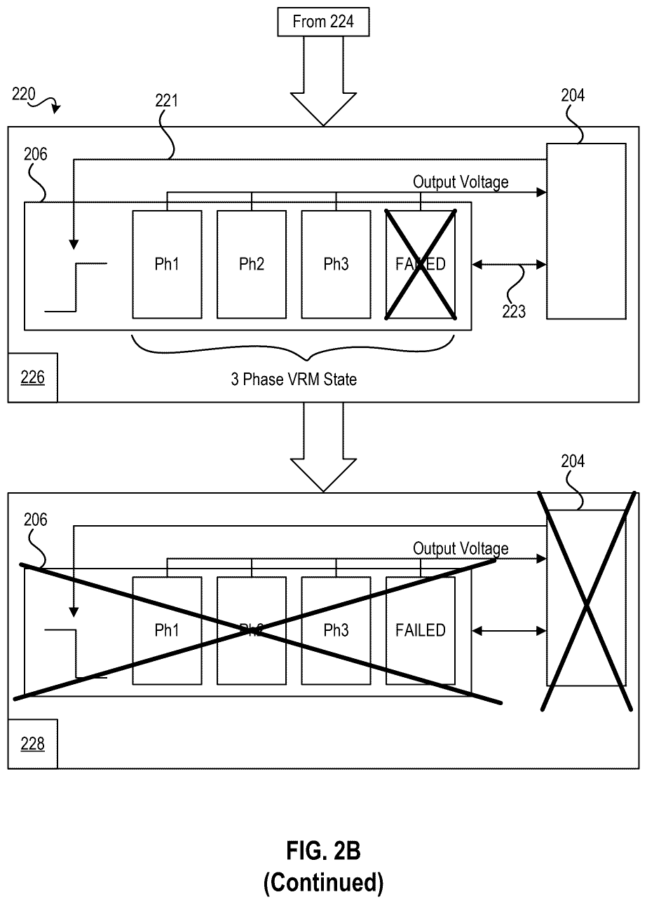

Looking now to FIG. 2A, a representational view of a processor system 200 with multiple chips is illustrated in accordance with one approach. As an option, the present processor system 200 may be implemented in conjunction with features from any other approach listed herein, such as those described with reference to the other FIGS., such as FIG. 1. However, such processor system 200 and others presented herein may be used in various applications and/or in permutations which may or may not be specifically described in the illustrative approaches or implementations listed herein. Further, the processor system 200 presented herein may be used in any desired environment. Thus FIG. 2A (and the other FIGS.) may be deemed to include any possible permutation.

As shown, the processor system 200 includes a central I/O chip 202 which is surrounded by several chips 204 (also referred to herein as “core die” or “taps”). While the present configuration is illustrated as including 8 chips 204 combined with the central I/O chip 202 to form an illustrative 9 core processor module, this is in no way intended to be limiting. For instance, other approaches may include 2, 4, 6, 8, 10, 12, 14, 16, 24, 36, etc. different chips combined with the central I/O chip 202.

Each of the chips 204 are connected to a respective VRM 206. The VRMs 206 thereby provide a CPU core voltage (Vcore) power supply voltage to the respective chips 204, running the processing cores of the processor system 200. The Vcore supplied by each VRM 206 to the respective chip 204 may be done using any desired type of connection that is capable of directing an electrical potential, e.g., such as a cable, a wire, a bus, etc. Depending on the approach, processor system 200 may be part of a CPU, GPU, or any other device with a processing core. For example, any approaches of the processor system 200 may be implemented in the computer 101 of FIG. 1, e.g., as would be appreciated by one skilled in the art after reading the present description. It should also be noted that the type of VRM implemented in a given approach may vary.

With continued reference to FIG. 2A, the fact that each VRM 206 is supplying a different (e.g., individual) power supply voltage allows for each chip 204 to receive a unique (e.g., different) and individually adjustable voltage. In other words, each of the chips 204 are fed their own, distinct voltage. As a result, the current for each chip is reduced, but the total number of chips increases significantly. Approaches herein are thereby able to achieve a unique power delivery configuration that differs from conventional products and improves performance as a whole.

Looking now to FIG. 2B, a progression 220 depicting how a VRM 206 and corresponding chip 204 react to a phase failure is illustrated in accordance with one approach. One or more of the steps in the progression 220 may be performed in accordance with the present invention in any of the environments depicted in FIGS. 1-2A, among others, in various approaches.

As shown, the first step 222 of progression 220 includes the VRM 206 supplying four different phases Ph1, Ph2, Ph3, Ph4 as an output voltage to the corresponding one of the chip 204. As an option, the present VRM 206 and/or chip 204 may be implemented in conjunction with features from any other approach listed herein, and therefore have been referenced using common numbering with FIG. 2A. However, such VRM 206 chip 204 pair and others presented herein may be used in various applications and/or in permutations which may or may not be specifically described in the illustrative approaches or implementations listed herein.

Referring again to FIG. 2B, the VRM 206 and chip 204 (e.g., chip) exchange phase count monitoring information. See 223. Moreover, an output 221 is provided from the chip 204 to the VRM 206. The output may be a regulator enable in some approaches, e.g., as would be appreciated by one skilled in the art after reading the present description. The phase count monitoring information and/or output may be used to relay real-time voltage demands on the chip 204. This insight may be used to set the different phases Ph1, Ph2, Ph3, Ph4 and the resulting output voltage. In some approaches one or more AI based models may be trained using repositories of example data and/or over time using results to be able to set each of the phases based on the received real-time data.

Looking now to step 224, there, at least one of the phases supplied by the VRM 206 experiences a failure event. The failure may result from any number of issues that impact performance of the VRM 206 and/or the phases therein. For example, the low-side field-effect transistor (FET) of a buck converter may fail short from drain to source, leading to an output to ground short of the VRM output. This can in turn lead to a “shoot through” event where the input to the buck converter experiences a direction short to ground, damaging the high-side FET and creating a permanent short from input to output of the buck converter. Moreover, power FETs can fail for a number of reasons, including hot carrier injection due to high electric field at device junctions, potentially leading to gate oxide damage and loss of gate control. It should also be noted that although Ph4 is shown as having experienced a failure in the present approach, any of the phases may fail over time. Although one of the phases has failed, the VRM 206 preferably incorporates a redundant phase. This allows the VRM 206 as a whole to be able to maintain an output voltage that permits chip 204 to run any desired combination of operations, applications, sub-applications, etc. without experiencing performance issues stemming from lack of voltage.

While the VRM 206 is able to maintain operation while one of the phases remains in a failed state, the chip 204 is at risk of experiencing issues in response to a second of the phases produced by the VRM 206 going offline. Thus, proceeding to step 226, the failed fourth phase Ph4 is identified and the VRM 206 is placed in a 3 phase state. This 3 phase state may initiate a controlled shutdown of the VRM 206 and chip 204 such that the VRM 206 may be repaired before any additional phases go offline and compromise the status of the chip 204. Any workloads that have been assigned to, but not initiated by, the chip 204 may thereby be offloaded therefrom. These offloaded workloads may be transferred to other active chips that may be connected to a same central I/O chip (e.g., see 202 in FIG. 2A). This desirably ensures that workloads are not timed out and/or ignored. Moreover, workloads that have already been initiated by the chip 204 may be completed before proceeding with the controlled shutdown of the VRM 206 and chip 204.

In response to the workloads being offloaded from and/or completed by the chip 204, step 228 of the progression 220 involves completing the controlled shutdown of the VRM 206 and chip 204. This effectively brings the VRM 206 and chip 204 pair offline from the overarching processor system used to process workloads received during runtime. While this somewhat limits the achievable throughput of the processor system, it avoids situations where a lack of sufficient phases causes performance issues and failures to occur in the chips themselves. For example, in a situation where the number of active phase counts transitions from N to N−1, where N is the number of phases required to support full load performance, this would lead to an overcurrent condition in the remaining phases without any action on the part of the load, potentially leading to a system crash.

Moreover, separating the supply voltages such that each chip is provided with a different (e.g., individual) power supply voltage allows for each chip to receive a unique (e.g., different) and individually adjustable voltage. As a result, a single chip may be taken offline in a controlled manner without impacting performance of the remaining chips in the processor system. This simply is not an option in conventional products that use the same supply voltage to power all chips. Approaches herein are thereby able to achieve a unique power delivery configuration that differs from conventional products and improves performance as a whole.

Approaches herein are thereby able to reduce the number of redundant phases that are supplied for each output. A processor is able to detect a failed VRM phase(s), isolate the VRM experiencing the failure, and shutdown the affected chip. This desirably allows for the approaches herein to implement deferred replacement of the VRMs through isolation of the offending chip in conjunction with the powering down of the VRM responsible for that chip. Again, monitoring the number of active VRM phases and isolating the associated chip through a controlled shutdown, combined with shutting down the voltage output associated with that chip when an N−1 condition is detected, desirably avoids any performance issues being experienced in the remaining chips.

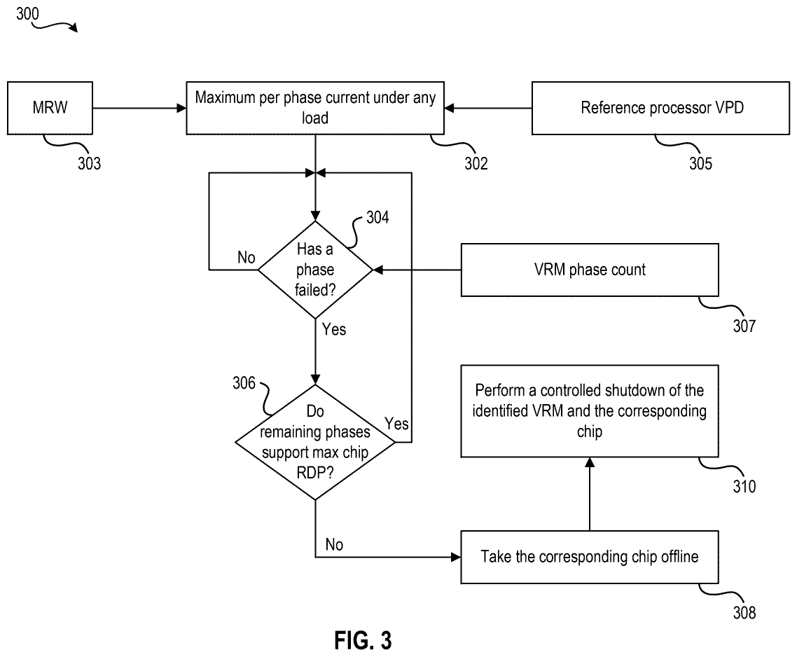

Looking now to FIG. 3, a flowchart of a computer-implemented method 300 for reducing the number of redundant VRM phases associated with maintaining operation of the underlying chip modules, is illustrated in accordance with one approach. As noted above, this is achieved at least in part through isolation of processor chips at critical ranges (e.g., thresholds) of redundancy loss, e.g., as will be described in further detail below.

The method 300 may be performed in accordance with the present invention in any of the environments depicted in FIGS. 1-2B, among others, in various approaches. Moreover, more or less operations than those specifically described in FIG. 3 may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. For instance, one or more operations in method 300 may be performed by components in the processor system of FIG. 2A. According to one approach, a central I/O chip may perform one or more of the operations in method 300. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes determining the maximum per phase current under any load. In other words, operation 302 includes determining the maximum current that a given one of the phases associated with sustaining a worst-case workload would carry. For example, a machine readable workbook may include vital product data corresponding to the processor which may be used to define a “worst case” situation for that module, as well as the respective chips. Accordingly, operation 305 involves referencing processor vital product data (VPD) to determine the maximum per phase currents for supporting any loading conditions.

It should be noted that while operation 302 is depicted as determining the maximum per phase current, different determinations may be made in other approaches. For instance, method 300 may alternatively include determining a minimum phase count associated with supporting a worst case chip workload. Operation 302 may thereby include determining a chip specific (e.g., core die scoped) machine-readable-workbook (MRW) value indicating the minimum number of phases that can be used to sustain a worst-case workload. In some approaches this number may be referenced and compared to the number and/or status of the phases detected from the VRM. In some approaches, a tap scoped MRW value which indicates the current delivery capability per phase for a VRM, may be determined and used to identify how the VRM is currently performing. Accordingly, in some approaches operation 302 involves referencing the received MRW 303.

As noted above, operation 302 may reference (e.g., read) processor VPD that outlines voltage levels associated with achieving different levels of performance and/or running certain combinations of applications, sub-applications, routines, etc. Accordingly, operation 305 involves referencing processor VPD to determine minimum phase levels for supporting worst-case loading conditions. The MRW value may be determined during manufacture of the processing system, developed over time based on performance, received from a user, determined based at least in part on industry standards, be predetermined based on the desired supply voltage, etc. According to a specific example, the MRW value is set by system engineers in response to learning the current delivery capabilities per phase of the VRM and the current consumption characteristics of the corresponding chip.

As mentioned above, action may be taken in response to the current carried by a given phase rising outside a predetermined range. Action may also be taken in response to the per chip phase count dropping below the MRW value, in an attempt to avoid performance issues. For instance, the software is notified to evacuate work from a chip and to stop dispatching jobs to it, e.g., as will be described in further detail below. However, it should be noted that determining whether a value is above a “threshold” or “outside a predetermined range” is in no way intended to be limiting. Rather than determining whether the number of active phases supplied from a VRM is above a MRW value (e.g., threshold), equivalent determinations may be made, e.g., as to whether the number of active phases is within a predetermined range, below a threshold, etc., depending on the desired approach.

Method 300 advances from operation 302 to operation 304. There, operation 304 includes determining whether any of the phases supplied by the VRM being inspected have failed. In other words, operation 304 determines if the VRM has become unable to supply one or more of the phases that are combined to produce the power supply voltage for the respective chip. As noted above, this determination may be made in some approaches by comparing a current number of phases being output by the VRM with a MRW value. Accordingly, operation 304 is illustrated as receiving the current number of phases (phase count) being produced by the VRM. See 307. In other approaches, the determination may be made by comparing a current output by the VRM to one or more predetermined ranges that are used to quantify performance of the VRM.

In some approaches, performing operation 304 involves monitoring each of the phases that are supplied by the respective VRMs and determining whether any have failed. As noted above, each of the VRMs in a processor system architecture are paired with a respective chip, thereby allowing for each chip to receive an individual and controllable supply voltage. Thus, monitoring the supply voltage that is provided by each of the VRMs provides valuable insight into the operating conditions of the corresponding chips.

The number of phases that are used to supply the operating voltage from a given VRM differs depending on the approach. However, a VRM preferably includes at least one redundant phase. Thus, the phases may be monitored by simply inspecting an output of the VRM and comparing it to expected values. However, additional details may be used in some approaches to determine the current status of the supply voltage being provided and whether it is sufficient to maintain performance. For instance, the current produced by the VRM may be monitored to gain further insight into the phases being produced by each of the VRMs and supplied to the corresponding chips. Accordingly, operation 304 may involve referencing a current produced by the VRM and/or received at the corresponding chip itself, to determine whether the present supply voltage is sufficient.

In response to determining none of the phases have failed, method 300 is depicted as circling back and repeating operation 304. This allows for the VRMs to continue to be monitored over time and for any phase failures to be identified relatively quickly. Operation 304 (and others in method 300) may thereby be repeated any desired number of times depending on the situation. In some approaches, method 300 may repeat operation 304 periodically by querying the number of active phases and/or output current after each predetermined amount of time has passed, in response to receiving instructions from a user, in response to one or more predetermined conditions being met, based on dynamic performance characteristics, etc.

In response to determining that at least one of the phases produced by a VRM being inspected has failed, method 300 is shown as proceeding from operation 304 to operation 306. There, operation 306 includes determining whether the remaining phases produced by the VRM are sufficient to support operations on the chip. In other words, operation 306 includes comparing the active phases with a number of phases associated with supporting worst-case loading conditions on the corresponding chip. This number of phases able to support a worst-case loading condition may be based at least in part on performance standards of the chip and/or any applications, sub-applications, processes, etc., that are run therein. In some approaches, the predetermined range includes 4 or more phases. In such approaches, method 300 returns to operation 304 in response to determining that each chip includes at least 4 phases being supplied thereto by the respective VRMs.

In response to determining that the number of active phases being produced by the VRM are sufficient to support worst-case loading conditions on the corresponding chip, method 300 is shown as returning to operation 304. In other words, method 300 returns to operation 304 such that performance of the VRM may continue to be monitored. However, in response to determining that the number of active phases produced by the VRM are not sufficient to support worst-case loading conditions on the corresponding chip, method 300 advances from operation 306 to operation 308. With respect to the present description, the number of active phases “sufficient” to support the worst-case loading conditions for a chip includes at least a number of phases that are able to supply a desired voltage at or below a specific current. Method 300 may thereby advance to operation 308 in response to determining that the total number of phases being produced by the VRM has been reduced to the point that there are no redundant phases being produced. For example, if a phase failure is experienced during run-time in a processor system architecture having only one redundant phase being produced by the VRM, method 300 would determine that an insufficient number of active phases exist and would advance from operation 306 to operation 308.

Looking now to operation 308, the chip that corresponds to (e.g., is correlated with) the VRM identified as producing an insufficient number of voltage phases is taken offline. Operation 308 thereby includes sending one or more instructions that result in any workloads that are currently assigned to the chip and associated with the identified VRM being offloaded. Any additional jobs are also prevented from being dispatched to the chip. In some approaches, the jobs that have already been initiated may be allowed to be completed during the process of taking the chip offline. In other approaches, any incomplete jobs (e.g., active workloads) may be transferred to another location (e.g., chip in the same processor system architecture).

A notification indicating that the identified VRM has an undesirably low number of functioning phases (e.g., is outside the predetermined range) may also be transmitted in response to advancing from operation 306 to operation 308. The notification may be sent to a user, an administrator, other chips in the same processor system, one or more AI based models (e.g., for training), etc. The notification may thereby initiate preemptively preparing the remaining VRM and chip pairs to receive at least some of the jobs that would otherwise be satisfied by the chip being taken offline.

From operation 308, method 300 advances to operation 310. There, operation 310 includes performing a controlled shutdown of the identified VRM and the corresponding chip. Thus, in response to the chip being taken offline, the VRM is turned off such that the output voltage is disabled in a manner that effectively powers off the chip. The controlled shutdown of the identified VRM and corresponding chip is also performed without any firmware intervention. In other words, the process by which the identified VRM and corresponding chip are taken offline follows a predetermined process that does not require any input from the underlying firmware. This desirably automates the improvements that are achieved by approaches herein, allowing for any chip to individually be protected from damage, corruption, data loss, etc.

As noted above, by taking a chip offline before a supply voltage issue emerges, approaches herein are desirably able to avoid any significant damage to the components therein, e.g., caused by overcurrent. Moreover, by implementing multiple VRMs such that each chip receives an individually controllable power supply voltage, approaches herein are desirably able to take specific chips offline while keeping remaining chips operational. Approaches herein are thereby able to achieve a unique power delivery configuration that differs from conventional products and improves performance as a whole.

Approaches herein are further able to reduce total number of redundant phases that are implemented in a given processor system while maintaining equivalent system availability. A processor module performing the operations of method 300 can also directly communicate with a VRM and monitor the number of active phases being received therefrom. Moreover, by evacuating workloads from a chip associated with a VRM having reduced output capability and disabling the corresponding output voltage without system firmware intervention, approaches herein are able to achieve significant improvements to performance across processor system architectures.

The improvements achieved by the approaches herein are particularly notable in comparison to the aforementioned conventional shortcomings as the number of supported voltages increases. For example, a conventional implementation having 8 VRMs would call for 5 phases per VRM, of which 2 phases are included for redundancy. As a result, the number of phases included for redundancy has increased to a significant 8×2=16 phases. These include 14 (+2) phases to support worst-case processor Vcore load (e.g., 500 A). As the number of supported voltages increases, 40 phases will need to be supplied in these conventional implementations, 16 of which are for redundancy for the worst-case Vcore load (e.g., 130 A for each chip). This increase in the number of phases has reached a physical limit in terms of what can practically be packaged in the available system volume. Reduction in the number of physical phases is desired, but while maintaining the availability of system redundancy.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
in a processor system architecture having a plurality of voltage regulator modules (VRMs) respectively associated with a plurality of chips, detecting a failed phase of a first VRM which causes the first VRM to have a number of functioning phases that is outside a predetermined range;
causing any workloads on a first chip associated with the first VRM to be offloaded; and
causing a controlled shutdown of the first VRM and the first chip to be performed,
wherein the plurality of VRMs respectively associated with the plurality of chips in the processor system architecture, excluding the first VRM and the first chip, remain operational.

2. The method of claim 1, wherein the predetermined range is based at least in part on an amount of the functioning phases associated with satisfying a performance standard of the first chip associated with the first VRM.

3. The method of claim 1, further comprising:
transmitting a notification indicating the first VRM has the number of functioning phases that is outside the predetermined range.

4. The method of claim 1, wherein the processor system architecture includes at least eight VRMs that are respectively associated with at least eight chips.

5. The method of claim 1, further comprising:
monitoring a current supplied by the respective VRMs; and
in response to the supply current provided by the first VRM being outside a second predetermined range, detecting the first VRM as having a number of functioning phases that is outside the predetermined range.

6. The method of claim 1, wherein the causing the controlled shutdown of the first VRM and the first chip to be performed includes:
in response to the workloads being offloaded from the first chip, causing an output voltage of the first VRM to be disabled.

7. The method of claim 6, wherein the controlled shutdown of the first VRM and the first chip is performed without firmware intervention.

8. The method of claim 1, wherein the predetermined range includes four or more phases.

9. A computer program product comprising:
one or more computer-readable storage media; and
program instructions stored on the one or more storage media to perform operations comprising:
in a processor system architecture having a plurality of voltage regulator modules (VRMs) respectively associated with a plurality of chips, detecting a failed phase of a first VRM which causes the first VRM to have a number of functioning phases that is outside a predetermined range;
causing any workloads on a first chip associated with the first VRM to be offloaded; and
causing a controlled shutdown of the first VRM and the first chip to be performed,
wherein the plurality of VRMs respectively associated with the plurality of chips in the processor system architecture, excluding the first VRM and the first chip, remain operational.

10. The computer program product of claim 9, wherein the predetermined range is based at least in part on an amount of the functioning phases associated with satisfying a performance standard of the first chip associated with the first VRM.

11. The computer program product of claim 9, wherein the operations further comprise:
transmitting a notification indicating the first VRM has the number of functioning phases that is outside the predetermined range.

12. The computer program product of claim 9, wherein the processor system architecture includes at least eight VRMs that are respectively associated with at least eight chips.

13. The computer program product of claim 9, wherein the operations further comprise:
monitoring a current supplied by the respective VRMs; and
in response to the supply current provided by the first VRM being outside a second predetermined range, detecting the first VRM as having a number of functioning phases that is outside the predetermined range.

14. The computer program product of claim 9, wherein the causing the controlled shutdown of the first VRM and the first chip to be performed includes:
in response to the workloads being offloaded from the first chip, causing an output voltage of the first VRM to be disabled.

15. The computer program product of claim 14, wherein the controlled shutdown of the first VRM and the first chip is performed without firmware intervention.

16. The computer program product of claim 9, wherein the predetermined range includes four or more phases.

17. A computer system comprising:
a processor set having an architecture which includes a plurality of voltage regulator modules (VRMs) respectively associated with a plurality of chips;
one or more computer-readable storage media; and
program instructions stored on the one or more storage media to cause the processor set to perform operations comprising:
detecting a failed phase of a first VRM which causes the first VRM to have a number of functioning phases that is outside a predetermined range;
causing any workloads on a first chip associated with the first VRM to be offloaded; and
causing a controlled shutdown of the first VRM and the first chip to be performed,
wherein the plurality of VRMs respectively associated with the plurality of chips in the processor set architecture, excluding the first VRM and the first chip, remain operational.

18. The computer system of claim 17, wherein the operations further comprise:
monitoring a current supplied by the respective VRMs; and
in response to the supply current provided by the first VRM being outside a second predetermined range, detecting the first VRM as having a number of functioning phases that is outside the predetermined range.

19. The computer system of claim 17, wherein the predetermined range is based at least in part on an amount of the functioning phases associated with satisfying a performance standard of the first chip associated with the first VRM.

20. The computer system of claim 17, wherein the controlled shutdown of the first VRM and the first chip is performed without firmware intervention.
